(19) United States
(12) Patent Application Publication
(10) Pub. No.: US 2017/0050057 A1
(43) Pub. Date: Feb. 23, 2017

(54) FILTERING FACE RESPIRATOR HAVING OPTIMIZED FACIAL FILTER LOCATION

(71) Applicant: Scott Technologies, Inc., Boca Raton, FL (US)

(72) Inventors: Alyssa Whitney SABOLIS, Weddington, NC (US); Chris WARD, Denbigshire (GB); Michael PARHAM, Weddington, NC (US); Ethan David VOSS, Charlotte, NC (US); Graham Peter WILSON, Flintshire (GB)

(21) Appl. No.: 15/307,234

(22) PCT Filed: Apr. 28, 2015
(86) PCT No.: PCT/US15/27923

§ 371 Date: Oct. 27, 2016

Related U.S. Application Data
(60) Provisional application No. 61/985,291, filed on Apr. 28, 2014.

(51) Int. Cl. A62B 23/02; A62B 18/02

(52) U.S. Cl. CPC A62B 23/02; A62B 18/025

(57) ABSTRACT

A respiratory mask has a filter element that is optimally position relative to the inhale and exhale of a wearer's nose and mouth in relation to the size and shape of the filter allowing a direct pathway of the airflow between the wearer's nose and mouth to the filter. A non-permeable section, incorporated in the filter element, filtering structure, the sealing area or a combination thereof, is used to direct and channel the outer dispersed boundaries of the nasal and oral flow to the filter element. The optimally positioned filter coupled with channeling of the boundary flow through the filter element reduces residency time of exhaled breath in the mask.

### CROSS-REFERENCE TO RELATED APPLICATION

This application claims the benefit of U.S. Provisional Patent Application No. 61/985,291 filed Apr. 28, 2014, the contents of which are incorporated herein by reference.

### FIELD OF THE INVENTION

The invention relates to respirator efficiency and comfort of a respirator user (also referred to as “wearer”).

### BACKGROUND OF THE INVENTION

Respiratory protection is important in many occupations where workers are exposed to gases, vapors, and/or aerosols (including dusts, mists and biological agents). Respirators come in a large variety of types and sizes, ranging from cheaper, disposable masks to higher cost, reusable facepieces with a replaceable filtration cartridge(s). The basic components of the majority respiratory devices include a filtering structure, a sealing area (as part of the filtering structure or as a reusable separate molded member present on many half-mask and full facepiece respirators) and some type of harness that holds the respirator on the user's face.

A common complaint and reason for user's intolerance of wearing respirators is driven by the user's discomfort. Human exhaled breath is naturally hot, humid and contains a high concentration of carbon dioxide, which is either partially encapsulated by a respirator or is not sufficiently evacuated and re-inhaled into the respirator during wear. The high temperatures, such as greater than approximately 95° F. and high carbon dioxide content, such as greater than 2% content (ambient levels at 0.04% content) within the microclimate of the respirator negatively impact the comfort and tolerability of the user, especially during repeated wear and long duration use.

Additionally studies of the dynamics of airflow from breathing and talking have been published, such as that exemplified in Gupta, J. K., Lin, C.-H., and Chen, Q., “Characterizing exhaled airflow from breathing and talking”, Indoor Air, 20, 31-39, 2010.

### SUMMARY OF THE PRESENT INVENTION

A respiratory mask has a filter element, the filter element optimally position relative to the inhale and exhale of a wearer's nose and mouth in relation to the size and shape of the filter allowing a direct pathway of the airflow between the wearer's nose and mouth to the filter. The respirator mask also includes a non permeable section that is incorporated as a shaped molded base composed of silicone, thermoplastic elastomer (TPR) or combination thereof and molded forming a face seal, a shaped support structure that houses the filter media or a combination thereof in which the non permeable section directs/channels the outermost boundaries of the nasal and oral flow to the filter element. The optimally positioned filter coupled with channeling of the boundary flow through the filter element reduces residency time of exhaled breath in the mask, increases efficiency of fully evacuating the mask of the exhaled breath and decreases the amount of exhaled air to be re-inhaled into the respirator.

### BRIEF DESCRIPTION OF THE DRAWINGS

The accompanying drawings, which are incorporated herein and constitute part of this specification, illustrate exemplary embodiments of the invention, and together with the description above, serve to explain further features of the invention.

FIG. 1A illustrates a side face breathing view for inhale and exhale nasal streams;

FIG. 1B illustrates a front face breathing view for inhale and exhale nasal streams;

FIG. 1C illustrates a side face breathing view for inhale and exhale oral streams;

FIG. 2A illustrates a side head view showing placement of a filter within a mask substantially covering areas of inhale and exhale to and from the wearer's nasal and oral streams of air flow;

FIG. 2B illustrates a side head view showing the ideal horizontal and vertical filter distance with respect to the face, distances referenced to common facial landmarks that are defined by the average end user population statistics;

FIG. 3 illustrates a front head view of the mask placed on the wearer's head and the filter properly placed and aligned to the wearer's nasal and oral breathing streams;

FIGS. 4A-4C illustrate a head view of the facepiece relative to the wearer and depicts two different variants of the types of filtering structures and shapes used to optimize placement location in the breathing zone;

FIGS. 5A-5B illustrate one embodiment of the support structure and filtering structure incorporating a hinged outer frame of the support structure that allows the filtering structure to be easily removed and replaced by simply opening and closing the outer frame; and,

FIG. 6 illustrates the user's field of view when looking downward, with little to no protrusion of the filtering structure or the support structure into the line of sight of the wearer.

### DETAILED DESCRIPTION OF THE PREFERRED EMBODIMENT

Human breath includes breathing from the mouth and nose with the airflow following separate air paths in from inhalation and exhalation actions. Proper placement of the filter element of a mask permits minimally disturbed airflow through the filter for both the mouth and nose.

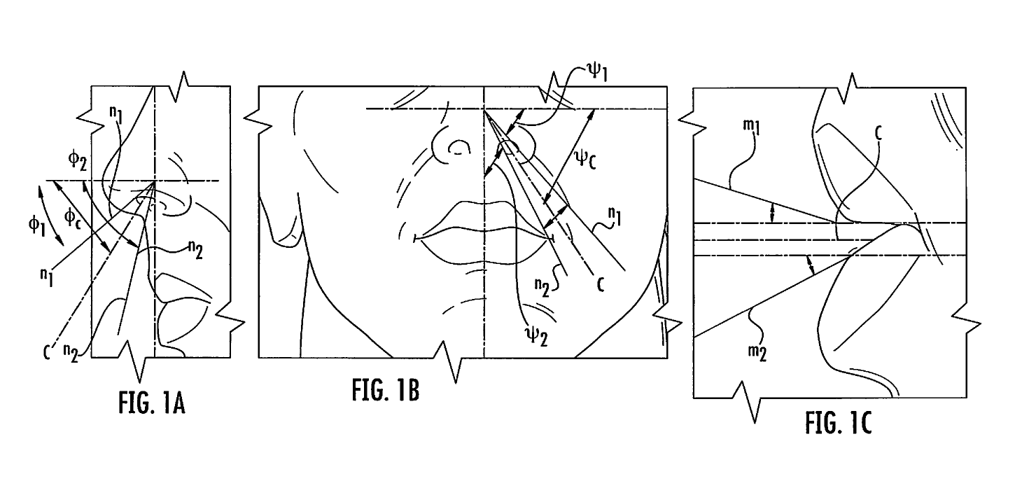

As seen in FIG. 1A that illustrates a side face breathing view for inhale and exhale nasal streams, this respiration airflow may, in part, be defined as an increasingly expanding air path cone shaped by the nose passageway with an increased radius extending from the nostrils of the nose. The outer boundaries of the airflow from the nostrils, shown as n1 and n2, is defined by the difference of two or more incident angles, shown as Φ1 and Φ2, for the outer envelope of the air path cone from the nose with a center Φc. Referring to FIG. 1B which illustrates a front face breathing view for inhale and exhale nasal streams of FIG. 1A, a three dimensional prospective is defined in a ninety degree offset from FIG. 1A, by showing the outer boundaries of the airflow from the front view of the nostrils defined by the difference of two angles of Ψ1 and Ψ2 for the outer envelope of the air path cone from the nose with a center Ψc. The values of the nasal boundary airflow angles in FIG. 1A-1B are measured through experimental means and statistically determined in conformity with such measurement, as described, for example in Gupta, J. K., Lin, C.-H., and Chen, Q., “Characterizing exhaled airflow from breathing and talking”, Indoor Air, 20, 31-39, 2010, the disclosure of which is incorporated herein by reference for such measurement determination. Representative values of the angles for the nasal boundaries are as follow: Φ1=48.5°+/−14°, Φ2=71.5°+/−14°, Φc=60°+/−6°, Ψ1=58.5°+/−10°, Ψ2=10.5°+/−10°, Ψc=69°+/−8°.

Referring to FIG. 1C which illustrates a side face breathing view for inhale and exhale oral streams, the outer boundaries of the airflow from the mouth are defined by m1 and m2 which may be defined with two or more incident angles, not shown. Similarly to the nasal airflow boundary conditions, the values of the oral boundary airflow angles in FIG. 1C are measured through experimental means and statistically determined in conformity with such measurement, as described, for example in Gupta, J. K., Lin, C.-H., and Chen, Q., “Characterizing exhaled airflow from breathing and talking”, Indoor Air, 20, 31-39, 2010. For example, the spreading angle of the oral airflow that is bounded by m1 and m2 may be approximately 30.25°+/−5°.

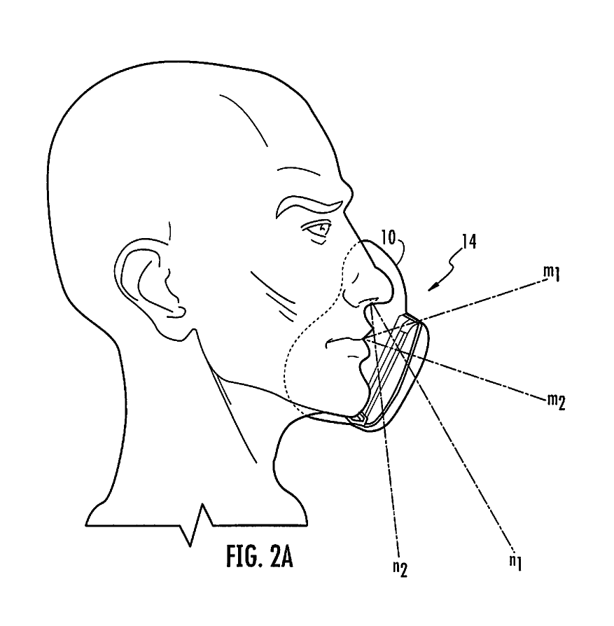

Referring to FIGS. 2-6, the invention includes a face mask 100 having a shaped molded base 10 forming a face seal 14 in combination with a shaped support structure 12 that is attached to the shaped molded base 10. The face seal 14 houses a filter media 20, and positions the filter media 20 within a substantial area envelope of both the oral exhale stream, m1 and m2 and nasal exhale stream, n1 and n2, which may be calculated through experimental data and/or theoretical calculation in light of Gupta, J. K., Lin, C.-H., and Chen, Q., “Characterizing exhaled airflow from breathing and talking”, Indoor Air, 20, 31-39, 2010, the disclosure of which is herein incorporated by reference for such purpose. The shaped molded base 10 preferably is composed of silicone, thermoplastic elastomer (TPR) or combination thereof and molded forming the face seal 14 with the shaped support structure 12 attached to the shaped molded base 10 and housing the filter media 20, and located in direct path of the oral and nasal exhale stream.

As seen in FIG. 2B, the proper placement of the filter media is also placed a distance away from the face as to accommodate many different facial types. Using commonly measured facial anthropometric features, the bottom of the chin CH and the furthest point of the nose protrusion NP are used as referencing points for the optimized plane of the filter location. A top angle a1 from about 45 degrees to about 95 degrees, more preferably from about 60 degrees to about 95 degrees, still more preferably from about 70 degrees to about 90 degrees and most preferably about 80 degrees; and a bottom angle a2 of from about 30 degrees to about 60 degrees, more preferably from about 35 degrees to about 50 degrees and most preferably about 45 degrees are used as boundaries for the top and bottom of the filter location. Rays a1A and a2A are parallel to the wearer's standing posture, such as the line formed from the intersection of the frontal (coronal) plane and sagittal (medial) plane relative to a human body, with a1B and a2B preferably combined to form an 80 degree angle therefrom. Any part of the filter above the a1B ray generally impacts the wearer's field of view and any part of the filter lower than a2B generally impacts the sealing of the mask on the chin and restricts head movement. The distance designated as A is a value greater than the NP measurement for a defined end user population, preferably greater 20%, more preferably greater than 25%, and most preferably greater than 30% of the average NP measurement for the defined end user population as statistically determined in conformity with such measurement, as described, for example, in Zhuang, Ziqing, et al. “Facial anthropometric differences among gender, ethnicity, and age groups.” Annals of occupational hygiene (2010): meq007, the disclosure of which is incorporated herein by reference for such measurement determination. Representative measurements of NP include, for example, placing a landmark (or visual indicator) at the tip of the nose or pronasale and the base of the nose or subnasale and using a sliding caliper to measure the distance between the two visual markers. Any distance less than A is not ideal for determining filter placement because it would cause the filter to be placed too close to the wearer's face and prevent proper distancing of the filter to the face. For example, people with larger noses will have a portion of their nose in contact with the filter and compromise the functional surface area of the filter itself. The distance designated as B is the maximum distance acceptable from the wearer's face to place the filter, with B having a value greater than the determined A distance and resulting from a calculation of the direction from the nasal and oral airflow creating a given impact on the filter for a defined group of wearers, but being no greater than about 8 inches from the wearer's face, preferably being from about 3 inches to about 8 inches away from the face, more preferably being from about 3 inches to 5 inches. The ideal placement for the filter is bounded to be within the distance of B but greater than the distance of A, and a1B and a2B rays for upper and lower vertical placement of the filter respectively. In this area, the filter encompasses from about 75% to about 100% of the combined nasal and oral airflow streams. For proper functionality and to consistently encompass the desired 75% to 100% of both the oral and nasal flow paths, the filter in this design is placed at a location far enough away from contacting the face to fit a wide range of facial sizes while still being located close enough to fully utilize the oral and nasal flow paths.

As seen in FIGS. 2A-B and 3, this proper placement of the filter media 20 preferably includes greater than or equal to about 75% of the area of impact by the average of both the nasal and oral airflows, more preferably greater than 85% of the area of impact by the average of both airflows, still more preferably greater than 95% of the area of impact by the average of both airflows and most preferably greater than 98% of at least one or each of the airflows, such as 100%. The filter 20 is sized and spatially fixed to substantially envelop the air paths from both the user's mouth and nose into the filter 20 of the mask 100. For a given distance of the mask (from FIG. 2B the ideal placement for the filter is bounded to be within the distance of B but greater than the distance of A, and a1B and a2B rays for upper and lower vertical placement of the filter respectively) from the user's face and facially centered along the center of the face, the position of the filter 20 aids in reducing turbulence of the airflow coming from and going into the filter 20. As such proper sizing of the filter 20 is achieved to effectively envelop the air paths by minimizing the area of the filter 20 and air path turbulence within the mask. When filters 20 are located in different distances (within the target filter location between distances A and B) and vertical locations from the wearer's nose and mouth (within the target filter location bounded by rays a1B and a2B) from wearing a different mask, the filter orientation and sizing change for the optimized placement of the filtering media 20.

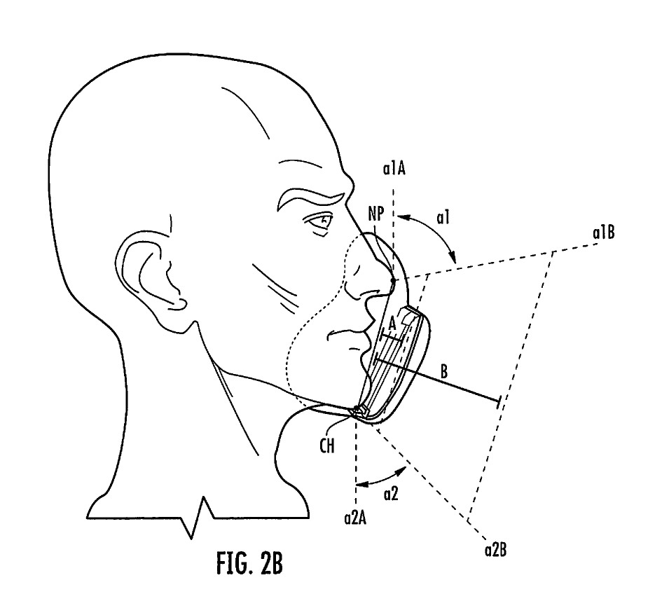

In addition to the vertical and horizontal location of the filter, the sizing of the filter also affects the functionality of the design. Depicted in FIG. 3, the three circles on the filtering unit 20 represent the surface area of the projected conical airflow streams of the left and right nasal flow (bottom 2 circles) and the mouth flow (top circle). Disposable respirators and surgical masks are almost entirely comprised of permeable filtering media (with the exception of head straps, attaching mechanisms, valves or added accessories to improve sealing to the face such as a strip of foam or a malleable nasal strip). The bulk of the mask is essentially a large filter that encompasses the wearer's bottom portion of the face (from the bridge of the nose to the chin and from the left to right ear). During use, the exhaled breath is dispersed across the permeable mask (not uniformly), dissipating the overall exhaled airflow speed and creating areas of turbulence and vortices that inhibit some portions of the flow to fully exit the mask. With a lower overall exhalation speed, the exhaled air that had escaped the mask may not have traveled a distance far enough away from the mask and will be re-breathed during the following inhale of the wearer. Due to the properties of the exhaled air and the airflow pattern caused by the filter media, a small boundary layer can form just above the outer surface of the mask, enhancing the effect of re-breathing in pre-exhaled air (that has the negative properties of exhaled air with respect to temperature and CO2 content). By limiting the size of the filtering area in conjunction of optimizing filter placement directly in the path of the oral and nasal airflow streams, the exhaled air's speed is maintained to exit the filter and mask to a distance that will not be re-breathed during inhalation and reduces the amount of turbulence inside the mask which entail reduces the amount of exhaled air trapped inside the mask. The maximum size of the filter is determined by the projected conical base surface area from the nasal and oral flow paths depicted in FIGS. 1A-1C. For the nasal airflow, the angle created by the rays n1 and n2 is approximately between 10 degrees and 40 degrees, more preferably between 20 and 30 degrees, and most preferably about 23 degrees. For the mouth airflow, the spreading angle created by rays m1 and m2 is approximately between 20 degrees and 40 degrees, and more preferably between 25 and 35 degrees and most preferably about 30 degrees. Given the angles for both nasal airflows and mouth airflow, the desired horizontal filter distance B, and the angle at which the filter is oriented with respect to the vertical reference of the wearer's standing posture, the projected conical base surface area can be calculated. The size of the filter defined as the two dimensional surface area it encompasses when assembled, for example a pleated filter has more functional surface area because of the added depth, but the design is most dependent on the restriction of size based on the filter fully pleated and assembled with respect to the two dimensional projection of the conical airflows. The filter's minimum size must be no less than 75% of the average surface area of both nasal and oral airflow projections. The filter's maximum size should be approximately no larger 200% of the average surface area of both airflow projections for a given set distance from the wearer's face, more preferably no larger than 175% and most preferably no larger than 150%. By restricting the overall size of the filter, the exhaled airflow can maintain a majority of its initial speed with the direct flow path and reducing flow dispersion across a large surface area of filter media, it allows for the exhalation air to be efficiently evacuated from the mask with little to no re-breathing of the evacuated air.

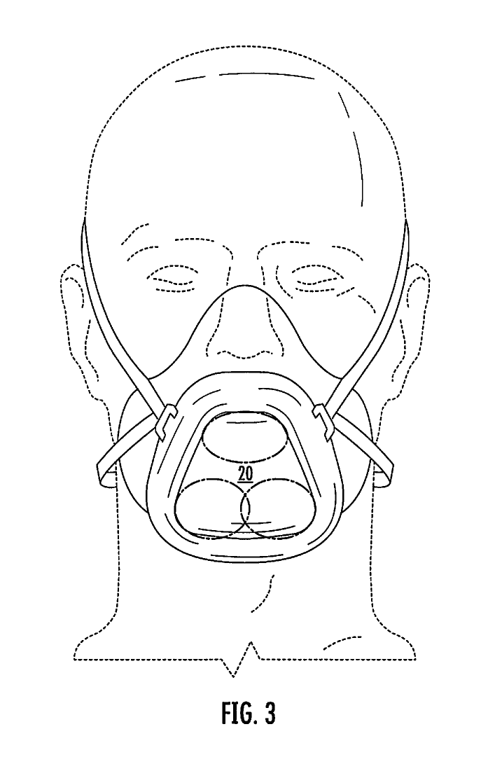

FIGS. 4A-4C illustrate a head view of the facepiece relative to the wearer and depicts two different variants of the types of filtering structures and shapes that can be used in the optimize placement location in the breathing zone which allow the filter placed in proper placement and alignment to the wearer's nasal and oral breathing streams. An elastomeric seal may be incorporated with the support structure 10 and filtering structure 12.

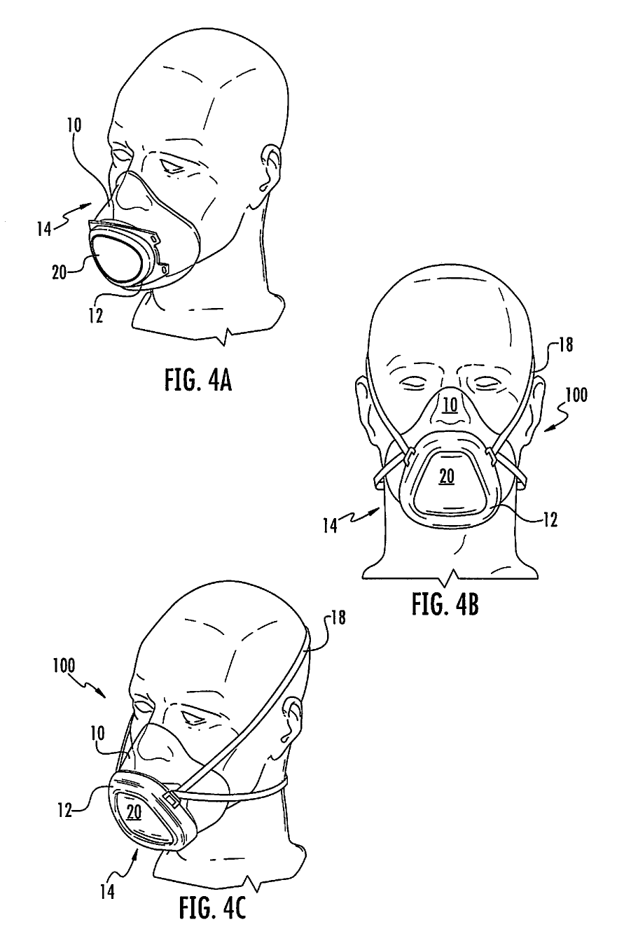

FIGS. 5A-5B illustrate an embodiment of the support structure 12 and filter 20 incorporating a hinged outer frame of the support structure 12 that allows the filter 20 to be easily removed and replaced by simply opening and closing the outer frame. Latches 32 are used to release the filter 20 about a hinge 30 for removal, replacement and/or servicing. As such this embodiment allows the support structure 12 and filtering structure 20 to incorporate a “hot swap” feature. This includes a hinged outer frame of the support structure 12 that allows the filtering structure, e.g., the filter pad, 20 to be easily removed and replaced by simply opening and closing the outer frame. The face mask allows for reuse and changing of filter media without doffing the respirator. This is advantageous in that personal protective equipment such as safety glasses, eyewear, face shields, head protection, and sanitary nets do not require doffing and donning when changing filter media between exposure scenarios such as healthcare worker to patient during triage and patient care during aerosol generating procedures such as incubation, spirometry, etc.

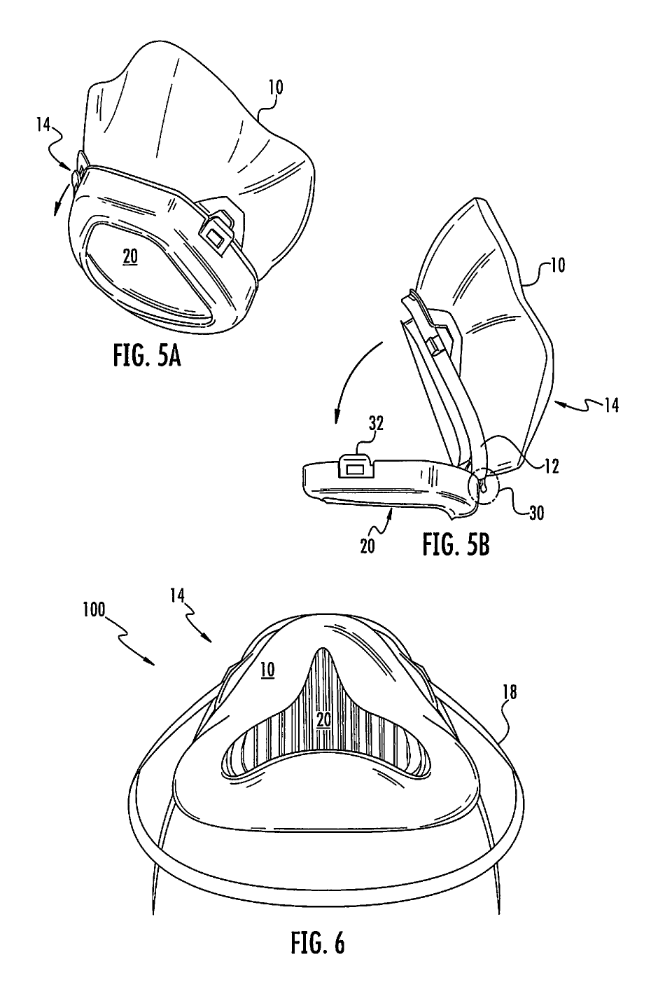

FIG. 6 illustrates the user's field of view when looking downward, with little to no protrusion of the filtering structure or the support structure.

In one preferred embodiment, the invention includes a semi-disposable face mask which has a shaped molded base composed of silicone, thermoplastic elastomer (TPR) or combination thereof and molded forming a face seal, additionally having a shaped support structure that is attached to the shaped molded base and houses the filter media, located in direct path of the oral and nasal exhale stream with a disposable filter pad, filter cartridge or combination thereof. The harness includes disposable or reusable compositions with materials that are easily sterilized with common methods.

The invention includes a filtering structure that is optimized to be located in the direct oral and nasal exhalation path and a non-permeable section used to direct and channel the outer dispersed boundaries of the nasal and oral flow to the filter element. By purposefully managing the airflow stream directly out of the mask, exhaled air is not able to reside within the deadspace of the mask for prolong amounts of time and allows for fresh air (lower ambient levels of CO2 and cooler air) to fill the mask during inhalation hence refreshing the user with clean comfortable air. If the exhaled air is not efficiently flushed from the mask after each breath, the residual air (containing the properties of exhaled air, high CO2 and high temperature will be re-inhaled causing discomfort to the user. Prolong use of mask only intensifies this discomfort if the exhaled air is not properly turned over. This invention allows for efficient and continually removal of exhaled air and intake of fresh ambient air, giving end users prolonged comfort during extended wear. Preferably the molded base seal geometry is simplified and optimized to be light weight and streamline to reduce overall “bulkiness,” reduce the deadspace volume to help mitigate the time in which the exhaled air resides in the mask and thereof user comfort with respect to heat and carbon dioxide, and reduce impedance in the user's field of view, especially when looking in the downward direction.

The invention may be used for a variety of different respiratory protection applications, including general use, industrial and healthcare workers. The facial sealing area preferably has a simplified elastomeric seal which is attached (in some fashion) to a support structure. This support structure houses the filtering structure (which can be a simple N95 filter pad (such as that manufactured by Scott Safety of Monroe, N.C., pleated P100 puck (such as that manufactured by Scott Safety of Monroe, N.C., a nuisance+particle filter cartridge or combination thereof) and seals the filtering structure to the elastomeric seal. Straps or a harness is attached to the filtering structure, the support structure, the elastomeric or a combination thereof.

By optimizing the placement of the filtering structure within the direct path of both the oral and nasal exhalation airflow stream and directing the outer dispersed boundaries of the nasal and oral flow to the filter element, the invention reduces the microclimate temperature and carbon dioxide content, and thereby increasing user comfort and tolerability by reducing exhaled air residency time within the mask, Filtering structure placement is optimized to both the front and side angles of breathing flow directions from oral and nasal passages. By incorporating an elastomeric seal for airflow boundary channeling in conjuncture with the optimized filter location, this allows the fitting and security properties of a half mask facepiece while significantly increasing effective management of the microclimate burden on a user.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A respiratory mask comprising:
a filter media, the filter media optimally positioned relative to the inhale and exhale of a wearer's nose and mouth in relation to the size and shape of the filter to allow a direct pathway of the airflow between the wearer's nose and mouth to the filter.

2. The respiratory mask of claim 1, wherein the filter media is positioned to not contact the wearer's face in the horizontal axis.

3. The respiratory mask of claim 1, wherein the filter media is at least 75% of the area of impact of both the nasal and oral airflows of the wearer.

4. The respiratory mask of claim 3, wherein the filter media is at least 85% of the area of impact of both the nasal and oral airflows of the wearer.

5. The respiratory mask of claim 4, wherein the filter media is at least 95% of the area of impact of both the nasal and oral airflows of the wearer.

6. The respiratory mask of claim 5, wherein the filter media is at least 98% of the area of impact of both the nasal and oral airflows of the wearer.

7. The respiratory mask of claim 1, wherein the filter media is not greater than 200% of the area of impact of both the nasal and oral airflows of the wearer.

8. The respiratory mask of claim 7, wherein the filter media is not greater than 175% of the area of impact of both the nasal and oral airflows of the wearer.

9. The respiratory mask of claim 8, wherein the filter media is not greater than 150% of the area of impact of both the nasal and oral airflows of the wearer.

10. A respiratory mask comprising:
a non-permeable section supporting a filtering structure, the filtering structure having a filter media optimally positioned relative to the inhale and exhale of a wearer's nose and mouth in relation to the size and shape of the filter to allow a direct pathway of the airflow between the wearer's nose and mouth to the filter.
